(19) United States
(12) Patent Application Publication
(10) Pub. No.: US 2008/0309656 A1
(43) Pub. Date: Dec. 18, 2008

(54) Dispaly Pixel Inversion Scheme

(75) Inventors: Roel Van Woudenberg, Eindhoven (NL); Hendrikus Willem Groot Hulze, Eindhoven (NL); Gerben Johan Hekstra, Eindhoven (NL); Ramon Pascal Van Gorkom, Eindhoven (NL); Robertus Hendricus Maria Wubben, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,262

(22) PCT Filed: Aug. 30, 2005
(86) PCT No.: PCT/IB05/52836

§ 371 Date: Feb. 26, 2007

(30) Foreign Application Priority Data
Sep. 3, 2004 (EP) 04104266.4

(51) Int. Cl. G09G 5/00; G09G 3/36

(52) U.S. Cl. 345/214; 345/87

(57) ABSTRACT

A display device (500) having a plurality of picture cells (502) is controlled by adding a phase change to the regular cyclic inversion scheme. Thereby, it is possible to overcome the drawbacks of DC build-up due to, e.g., de-interlaced images and images comprising rotating symbols and “ticker tape”. The control involves receiving an image signal comprising image data relating to the picture cells. A respective electric field across each picture cell is controlled, in dependence on at least the image data, according to a first polarity inversion scheme where the polarity of the electric field is such that polarity inversion occurs at regular intervals, and according to a second polarity inversion scheme concurrent with said first polarity inversion scheme, where the polarity of the electric field such that polarity inversion occurs at pseudo-random intervals.

### TECHNICAL FIELD

The present invention relates to a display device and a method of controlling a display device in order to avoid build-up of unwanted electric charges in picture cells of the display device.

### BACKGROUND

Picture cells in a liquid crystal display (LCD) device obtain their transmission characteristics depending on the strength of the electric field across the cell. The electric field across each cell is depending on the content of an image data signal provided from an image source. The data of the image data signal is temporally arranged in a continuous sequence blocks of image data, where each block of data contains data values for each cell corresponding to voltage values to be applied across each cell at regular refresh intervals. Typically, blocks of image data and refresh intervals are referred to as image frames and frame periods.

In principle, the transmission characteristics of a picture cell is independent of the direction of the electric field across the cell, i.e. the polarity of the electric field. However, during a period of several frame durations a build-up of a biasing charge occurs, resulting in a biasing electric field across the cell. Such a biasing electric field is not desirable since it will change the transmission characteristics of the cell.

To overcome this build-up of a biasing electric field, the polarity of the electric field across the cell is inverted at regular intervals, typically every frame period, defining a so-called polarity inversion scheme. This scheme results in the long term average of the electric field being essentially zero with no biasing build-up of charges in the cell. In a display device comprising a matrix of picture cells, this polarity inversion scheme usually also involves a spatial configuration such that the inversion also takes place, e.g., at every other row and every other column. That is, during every even numbered frame the picture cells of every even numbered row and column are provided with electric fields having a polarity of a first direction and the picture cells of every odd numbered row and column is provided with electric fields having a polarity of a second direction. During every odd numbered frame the polarity inversion takes place and the picture cells of every even numbered row and column is provided with electric fields having a polarity of the second direction and the picture cells of every odd numbered row and column is provided with electric fields having a polarity of the first direction.

Usually, prior art devices that utilize such an inversion scheme perform satisfactorily when the image data signal does not contain image data having cyclic changes with periods that are more or less commensurate with the period of the inversion scheme. But when such commensurabilities exist, the problem of build-up of charge will be present. One example of such image content is de-interlaced image data, i.e. frames of image data that is composed of two or more sub-fields of image data that have been combined to progressive image frames. Needless to say, de-interlaced image data is widely used, for example when displaying television standard (e.g. PAL) signals on a LCD device. Another example of image data that may be commensurate with the inversion scheme is rotating symbols and “ticker tape” that are common in present day television programs.

In the European patent specification EP 686958 a display apparatus and a method of driving a display panel is described, which aims at overcoming a problem of DC build-up when displaying de-interlaced image data on a LCD. Reversal of the polarity inversion is controlled such that, in addition to reversal every frame period, the polarity is inverted every n frame periods, where n is a predetermined number of frame periods.

A drawback with the solution disclosed in EP 686958 is that it has difficulties in handling other image content that may cause DC build-up, such as rotating symbols and “ticker tape”, as discussed above.

### SUMMARY OF THE INVENTION

An object of the present invention is hence to overcome the drawbacks related to prior art display devices.

The object is achieved by way of a method according to claim 1 and a device according to claim 11.

According to a first aspect of the present invention, a method of controlling a display device having a plurality of picture cells, comprises the steps of:
receiving an image signal comprising image data relating to said plurality of picture cells, said image data being temporally arranged in frames,
controlling, in dependence on at least said image data, a respective electric field across each picture cell in said plurality of picture cells, comprising the steps of:
controlling, according to a first polarity inversion scheme, polarity of the electric field such that polarity inversion occurs at regular intervals, said regular intervals being a fixed integer number of frame periods, and
controlling, according to a second polarity inversion scheme concurrent with said first polarity inversion scheme, polarity of the electric field such that polarity inversion occurs at pseudo-random intervals, said pseudo-random intervals being a respective integer number of frame periods.

By introducing such a control method, i.e. adding a phase change to the regular cyclic inversion scheme, it is possible to overcome the drawbacks of DC build-up due to, e.g., de-interlaced images and images comprising rotating symbols and “ticker tape”. This is an advantage in that it makes the invention more versatile in terms of providing good results for a wide variety of image data.

A further advantage is obtained in a preferred embodiment where the number of frame periods between two consecutive polarity inversions according to the second scheme is less than a predetermined upper limit. This guarantees that the fixed phase relation of the regular cyclic inversion scheme is always broken in a finite time.

Yet a further advantage is obtained in a preferred embodiment where the number of frame periods between two consecutive polarity inversions according to the second scheme is greater than a predetermined lower limit. This guarantees that there will not be two or more changes of phase of the inversion in immediate succession, i.e. from one frame period to the next, which prevents any individual picture cell from experiencing three or more frame periods with one polarity of the electric field.

In a further embodiment, the number of frame periods between two consecutive polarity inversions according to the second scheme is an even number. This guarantees that any individual picture cell experiences an equal number of frame periods with an electric field having a first direction and an electric field having a second direction, respectively. In more general terms, a preferred embodiment is realized such that the second polarity inversion scheme is such that, considering a large number of frame periods, the number of pseudo-random polarity inversions in a first direction is substantially equal to the number of pseudo-random polarity inversions in a second direction opposite to the first direction. Preferably, the number of frame periods between two consecutive polarity inversions according to the second scheme is in the interval 4 to 3600 and even more preferably in the interval 60 to 600.

The image can be improved further by selectively deciding whether to add the extra phase jumps or not. Hence, a further improvement is obtained in a preferred embodiment that also comprises the step of:
analyzing the image data, resulting in at least calculated correlation values between a number of respective frame pairs, and wherein:
the number of frame periods between two consecutive polarity inversions according to the second scheme is depending on results from the image data analysis.

By introducing a step of analyzing the image data, yielding correlation values between frames, it is hence possible to adapt the inversion scheme to the particular type of image data that is currently being displayed. This is advantageous in that it allows changing of the inversion scheme, e.g., only at scene changes in the image sequence and thereby disguising any flickering of the image as perceived by a viewer when the inversion takes place.

The number of frame periods between two consecutive polarity inversions according to the second scheme may, in an embodiment, be set to an essentially infinite number, thereby essentially disabling the second inversion scheme. This is advantageous if, e.g., it is discovered that the pseudo-random inversion scheme introduces visible effects such as low frequency flickering of the displayed images, while the image content is such that no DC-build up can occur.

Moreover, in a preferred embodiment, the method utilizing the results from image data analysis can be improved in that the number of frame periods between two consecutive polarity inversions according to the second scheme is set to be less than a predetermined upper limit and where the upper limit depends on results from the image data analysis. The number of frame periods between two consecutive polarity inversions according to the second scheme may, similarly, be set to be greater than a predetermined lower limit and where the lower limit depends on results from the image data analysis.

It is to be noted that the term frame is used here to describe blocks of image data, where each block of data contains data values for each cell corresponding to voltage values to be applied across each cell at regular refresh intervals.

### BRIEF DESCRIPTION OF THE DRAWINGS

FIGS. 1a and 1b are schematic illustrations of polarity distributions of picture cells in a display device utilizing a known polarity inversion scheme.

FIGS. 2a-d are schematic illustrations of polarity distributions of picture cells in a display device utilizing a known polarity inversion scheme, illustrating a problem with de-interlaced image data.

FIGS. 3a-d are schematic illustrations of polarity distributions of picture cells in a display device utilizing a known polarity inversion scheme, illustrating a problem with regularly changing image content.

FIGS. 4a-h are schematic illustrations of polarity distributions of picture cells in a display device utilizing a polarity inversion scheme according to the invention with de-interlaced image data.

FIG. 5 is a schematic block diagram of a display device according to the present invention.

### PREFERRED EMBODIMENTS

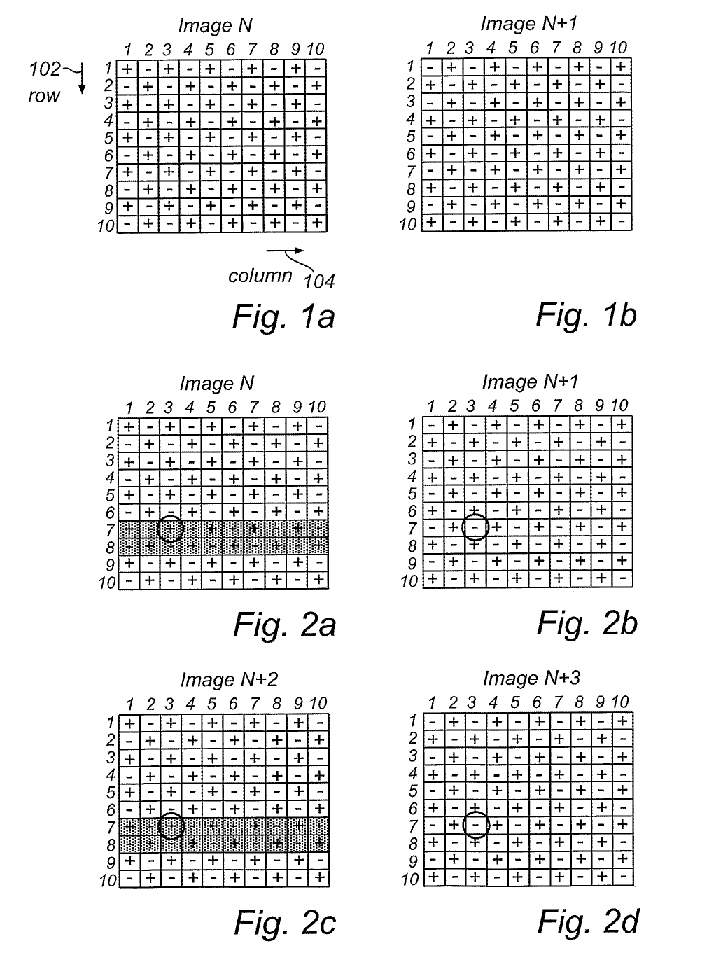

In what follows, a number of image data frames will be schematically illustrated, comprising 100 picture cells (or pixels) arranged in 10 rows by 10 columns, as indicated by arrows 102, 104 in FIG. 1a. In the image data frames of FIGS. 1 to 4, the picture cells that contain a dotted pattern illustrate bright (as perceived by a viewer) pixels and white cells represent dark pixels. A plus (+) sign represents a positive driving level, i.e. the sum of a common voltage level and a voltage level representing the data of the pixel in the image data signal. A minus (−) sign represents a negative driving level, i.e. the difference between a common voltage level and a voltage level representing the data of the pixel in the image data signal.

An LCD picture cell changes its transmission depending on the strength of the electric field over the cell, i.e. irrespective of the polarity of the field. A known problem related to LCD's is that a long-term voltage bias results in the cell drifting away from its neutral state. To compensate for this, LCD's are usually driven with pixel inversion. That is, each pixel is driven during one image frame with a positive data voltage, and during the next image frame with a negative data voltage. As a result, the long-term voltage over a cell averages out when the same data level is applied for a long period. In order to also reduce the visibility of possibly slight differences in, e.g., cell transmission between the two inversion phases, this inversion is usually done pixel-by-pixel and line-by-line, with an overall inversion being applied between every frame. In this way, spatial variations cancel out. FIGS. 1a and 1b illustrate this situation where, during image frame N, the distribution of positive and negative driving levels is as depicted in FIG. 1a and where, during image frame N+1, the distribution of positive and negative driving levels is as depicted in FIG. 1b. Picture cells that in FIG. 1a have positive driving levels have in FIG. 1b negative driving levels, and vice versa.

Variations of these schemes are known. For example, it is possible to utilize other groupings of cells, such as two by two, in rows or in columns, as the person skilled in the art will realize.

When this polarity inversion scheme is not applied, an electric charge will build up in the cell over time, causing an offset to the drive levels in later use, which reflects in the picture as image retention. Moreover, when a charge is built up during a longer time, the LC picture cell may even be damaged, without being able to recover.

Typically, prior art LCD panels and LCD driving circuitry use the inversion scheme as described above. Although this scheme works very well in general, it cannot handle some specific, regularly occurring image content, examples of which include de-interlaced image content, image content such as rotating symbols and ticker tape that are common in today's TV-shows.

Turning now to FIGS. 2a-d, charge build-up due to fine horizontal lines in interlaced image material will be discussed.

The separate fields of interlaced image data must be de-interlaced before the LCD panel can present a whole image to a viewer, as it needs data for all rows, not just the odd or even ones that are present in the respective interlaced image fields. A widely used method is to use line repetition where each line in the input (interlaced) image field is repeated, such that a progressive image is obtained. A further improvement is to use in-field scaling, which gives a somewhat better result, but for the sake of clarity and simplicity, in-field scaling can be seen as a similar (basically blurred/smoothed) variation of line repetition. As a result of the de-interlacing process the line is visible with doubled height (rows 7 and 8) in the image frame presented on the LCD panel in image N and N+2, and absent in image N+1 and N+3, as illustrated in FIGS. 2a-d. For the pixels in the area of this line, this results in a non-zero average voltage over the cells. For example, considering the pixel within the circle in FIGS. 2a-d, i.e. at the position defined by row 7, column 8, it has an average voltage over the cell of 0.5*((V_{c}+V_{data}−V_{c})+V_{c}−V_{c})=0.5*V_{data} V, while the pixels in, e.g., row 4 all have seen a net average voltage of 0 V. Here, V_{c} denotes a common voltage level and V_{data} denotes a voltage level representing the data.

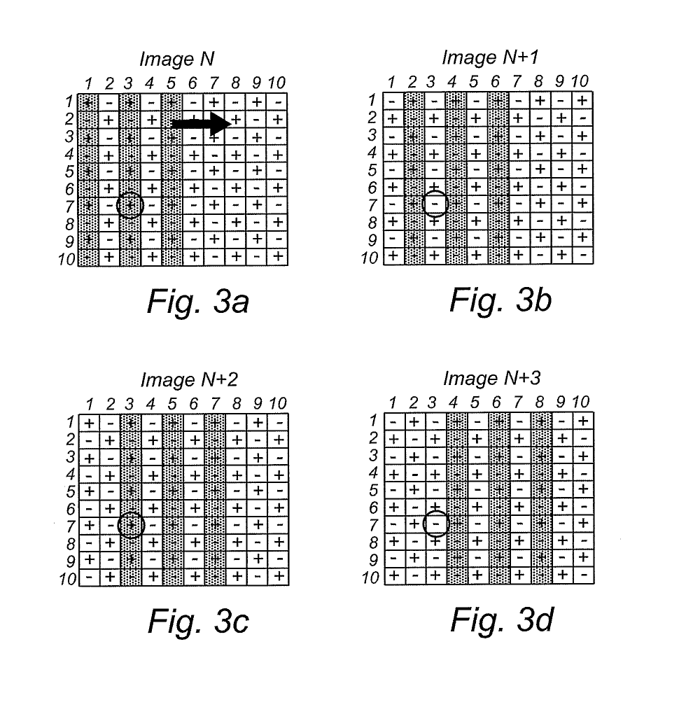

Another illustration is that of image content such as rotating symbols and ticker tape, which can be more simply represented as a moving grid of fine vertical lines. This is illustrated in FIGS. 3a-d. As the grid moves at 1 pixel per image frame to the right, as indicated by the arrow in FIG. 3a, the average voltage over e.g. the cell within the circle is again not zero, but 0.5*V_{d}V.

The present invention introduces a method to overcome these problems by way of pseudo-randomly invert the phase of the inversion scheme, i.e. to repeat the same inversion phase at some randomly selected moments in time, rather then sticking to the regularly occurring inversion. This is motivated by the observation that the problems described above occur when the dynamic video content is in phase with the inversion scheme.

This can be counteracted by changing the phase of the polarity inversion at some random moments at a low frequency, typically several 10 to several 100 times slower than the display update frequency (frame rate).

Typically, build-up of unwanted electric charge reaches the level at which it becomes noticeable on a timescale on the order of a minute, which means 3600 frame periods when a 60 Hz refresh rate is used. The lower limit on the number of frame periods between the phase inversions is determined by the visibility of flicker. Assuming a refresh rate of 60 Hz, this would mean that the shortest time period correspond to four frame periods, and it can be assumed that flicker is not visible when it is at a rate of 1 Hz (i.e. 50-60 frames) or lower. Hence, a preferred range for the number of frame periods between two phase changes is 4 to 3600 and even more preferred is a narrower range of 60 to 600.

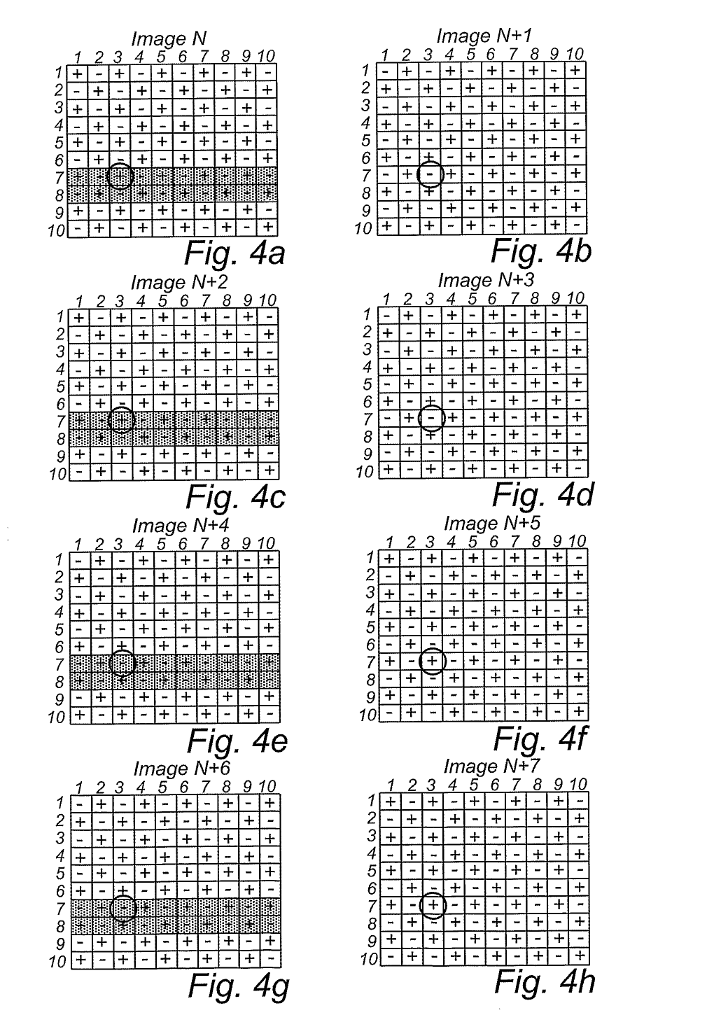

In FIGS. 4a-h, the effect of the inversion scheme according to the present invention is shown for the horizontal lines in deinterlaced image frames: the inversion scheme is inverted between image frame N+3 and image frame N+4, i.e. the inversion phase of the frame N+4 is the same as for the previous frame N+3 instead of being opposite. This results in an overall average of drive voltage over the cell of 0 V.

The inversion phase change should preferably be done randomly or, rather, pseudo-randomly, since that is the most robust solution for a wide variety of types of image content. A fixed inversion change frequency, as in prior art solutions, will most likely result in artifacts being present for some specific types of images, with harmful phase relations between inversion scheme, driving levels and dynamic image content.

Another embodiment is one in which the pseudo-random change of phase is controlled, such that there is an upper limit to the number of frames between two successive phase changes. This guarantees that the fixed phase relation is always broken in a finite time. Also a lower limit will guarantee that there cannot be two phase jumps in immediate succession (which would lead to a pixel seeing three times the same voltage in succession, that is, a “+++” or “−−−” voltage sequence, before getting inverted again.

A further embodiment is one in which the pseudo-random change of phase is controlled in such a manner that zero charge build-up is maintained also over longer time periods. By guaranteeing an equal number of occurrences of positive and negative drive for a pixel, over a given amount of time, achieves this.

Define f(n) as the basic inversion scheme for frame n, with:

f(n)=(−1)ⁿ

which signifies the choice for positive (+1) or negative (−1) drive imposed by driving circuitry on the picture cells.

The inversion scheme f′(n) can be defined with a random jump g(n) as given by:

f′(n)=g(n)·f(n)

The random jump function takes on the values (+1) to maintain the inversion scheme, and (−1) to “invert” the inversion scheme. This is the inversion control. The jumps in the scheme occur when g(n) goes from (+1) to (−1) and vice versa.

To guarantee that no DC drift (charge build-up) occurs for static images, the random jump g(n) is controlled to satisfy:

$${F}_{static} = {\sum }_{i} {f}^{′} ( i ) ≅ 0$$

over longer time, and controlled not to drift too far off from zero.

One very easy way to realize this is by way of causing jumps in the inversion only after an even number of frames. In this way, an equal number of positive and negative drives is guaranteed.

A further embodiment is where the pseudo-random change of phase is controlled such that zero charge build-up is maintained over longer time, and more generally for a wider variety of dynamic content.

To guarantee that no DC drift occurs for dynamic images with repetition rate 2 (e.g. deinterlaced material), the random jump g(n) is controlled to satisfy:

$${F}_{2} = {\sum }_{i} {f}^{′} ( 2 i ) ≅ 0$$

over longer time, and controlled not to drift too far off from zero.

Similarly, the random jump g(n) is controlled such that no charge build-up occurs for dynamic images with other (common) repetition rates, and satisfying:

$${F}_{N} = {\sum }_{i} {f}^{′} ( N i ) ≅ 0$$

One way to realize this is to implement a number of counters to calculate the values of F_{static}, F₂, F₃, . . . and based on their value, or drift away from zero, influence (or force) the probability of a jump in the inversion scheme.

These methods reduce the charge build-up problems. However, the skipping of the inversion (i.e. the random phase jumps) may be visible to a viewer. Depending on the time interval between the phase jumps this can be seen as a low frequency flicker or a brightness variation in the image.

The present invention solves this problem in a preferred embodiment by way of detecting whether it is necessary to do the phase jumps in the inversion scheme. This is achieved by selectively disabling the phase jumps depending on whether an interlaced signal (or image frames having “bad” content) is present or not.

Consider first the case with a display having a memory-less deinterlacer. In case an interlaced source is connected to the LCD (TV or monitor), e.g. a PAL source, it is necessary to add the extra phase jumps. Also in the case where progressive images are overlaid on top of an interlaced signal, e.g. an On Screen Display (OSD) over a PAL signal, then the extra phase jumps must also be added to the inversion scheme.

In the case that a progressive source is present it can either be assumed that the signal is good, i.e. not needing correction by way of a phase jump in the polarity inversion scheme as described above, and the extra phase jumps may be disabled; or a detection can be made to determine whether the material was once deinterlaced with a bad deinterlacer or contains “bad content”. This can, e.g., be done by storing one or more lines (or even the sum of intensities of the lines) in a memory and compare the content over several frames. Then detection can be made to determine whether the content of, e.g., frame i is more correlated with frame i+1 than with frame i+2. In this way, correlations over a longer time scale can be detected. If it is detected that the image was badly deinterlaced (or contains bad content) then the extra phase jumps are applied in the inversion scheme, otherwise the extra phase jumps are disabled.

Alternatively, instead of completely disabling the phase jumps, it is instead possible to increase the time between the phase jumps and, even more generally, setting the period between the phase jumps as depending on the correlation values that have been calculated.

For a display device having a good deinterlacer, such as a memory based deinterlacer that performs field insertion, this scheme can be applied with some modifications. In case an interlaced source is connected to the LCD (TV), the normal deinterlacer is used, which should not result in any problems and hence the extra phase jumps can be disabled. Optionally a detection can be made whether or not bad content is present in the image frames. If bad content is present then the phase jumps can be added as a precaution. However, the bad content is less likely to cause problems because it has to pass the deinterlacer, which reduces the problem.

If a progressive source is present then it can either be assumed that the signal is good, and the extra phase jumps can be disabled, or a detection can be made to determine whether the images have once been deinterlaced with a bad deinterlacer or contain bad content, as described above. If the images were badly deinterlaced or contains bad content then the signal should be improved with the “good” deinterlacer or the extra phase jumps in the inversion scheme can be applied.

It is to be noted that, in order to minimize the visibility of the phase jumps they are preferably applied at scene changes between images in an image sequence. This might at first glance seem unnecessary as the image content is likely to change from one scene to the next, but sometimes a ticker tape or small symbol, such as a channel logo, is present in the image before and after the scene change. Also note that the extra phase jumps occur preferably at an even number of frames (n is even).

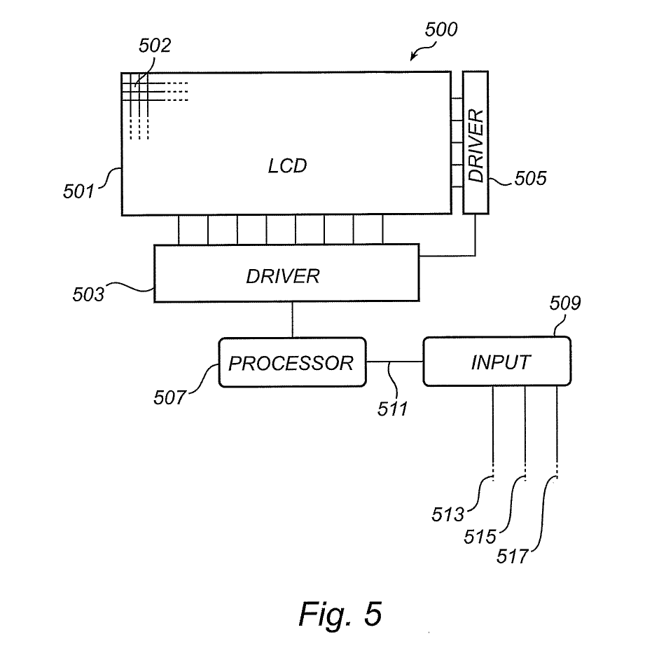

A block diagram of a LCD device 500 according to the present invention is shown in FIG. 5. Picture cells 502 of a LCD panel 501 are provided with respective driving voltages from column driving circuitry 503 and row driving circuitry 505. Data for the driving circuitry 503, 505 is provided by image data processing circuitry 507, which receives image data from any selectable image data signal source 513, 515, 517 as selected by input processing circuitry 509. The image data signal sources 513, 515, 517 may be of any kind known in the art, including interlaced signals such as PAL and NTSC, non-interlaced, i.e. progressive, signals such as DVI.

The input processing circuitry 509 analyses the input signal and decides whether or not the signal is to be deinterlaced. This decision is based on information regarding signal type and content of the input signal, as discussed above, as well as on the type of deinterlacer present in the image data processing circuitry 507.

The input processing circuitry 509 also analyses the input signal and decides whether or not polarity inversion control is to be performed by the column driving circuitry 503 and row driving circuitry 505. The inversion control is also determined by the type and content of the input signal and type of deinterlacer which is present.

Hence, to summarize, a display device having a plurality of picture cells is controlled by adding a phase change to the regular cyclic inversion scheme. Thereby, it is possible to overcome the drawbacks of DC build-up due to, e.g., de-interlaced images and images comprising rotating symbols and “ticker tape”. The control involves receiving an image signal comprising image data relating to the picture cells. A respective electric field across each picture cell is controlled, in dependence on at least the image data, according to a first polarity inversion scheme where the polarity of the electric field is such that polarity inversion occurs at regular intervals, and according to a second polarity inversion scheme concurrent with said first polarity inversion scheme, where the polarity of the electric field such that polarity inversion occurs at pseudo-random intervals.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method of controlling a display device (500) comprising a plurality of picture cells (502), comprising the steps of:
receiving an image signal (513, 515, 517) comprising image data relating to said plurality of picture cells, said image data being temporally arranged in frames,
controlling, in dependence on at least said image data, a respective electric field across each picture cell in said plurality of picture cells, comprising the steps of:
controlling, according to a first polarity inversion scheme, polarity of the electric field such that polarity inversion occurs at regular intervals, said regular intervals being a fixed integer number of frame periods, and
controlling, according to a second polarity inversion scheme concurrent with said first polarity inversion scheme, polarity of the electric field such that polarity inversion occurs at pseudo-random intervals, said pseudo-random intervals being a respective integer number of frame periods.

2. The method according to claim 1, wherein the number of frame periods between two consecutive polarity inversions according to the second scheme is less than a predetermined upper limit.

3. The method according to claim 1, wherein the number of frame periods between two consecutive polarity inversions according to the second scheme is greater than a predetermined lower limit.

4. The method according to claim 1, wherein the number of frame periods between two consecutive polarity inversions according to the second scheme is an even number.

5. The method according to claim 1, wherein the second polarity inversion scheme is such that, considering a large number of frame periods, the number of pseudo-random polarity inversions in a first direction is substantially equal to the number of pseudo-random polarity inversions in a second direction opposite to the first direction.

6. The method according to claim 1, wherein the number of frame periods between two consecutive polarity inversions according to the second scheme is in the interval 4 to 3600.

7. The method according to claim 6, wherein the number of frame periods between two consecutive polarity inversions according to the second scheme is in the interval 60 to 600.

8. The method according to claim 1, further comprising the step of:
analyzing the image data, resulting in at least calculated correlation values between a number of frames, and wherein:
the number of frame periods between two consecutive polarity inversions according to the second scheme is depending on results from the image data analysis.

9. The method according to claim 8, wherein the number of frame periods between two consecutive polarity inversions according to the second scheme is set to an essentially infinite number, thereby essentially disabling the second inversion scheme.

10. The method according to claim 8, wherein the number of frame periods between two consecutive polarity inversions according to the second scheme is less than a predetermined upper limit and where the upper limit depends on results from the image data analysis.

11. The method according to claim 8, wherein the number of frame periods between two consecutive polarity inversions according to the second scheme is greater than a predetermined lower limit and where the lower limit depends on results from the image data analysis.

12. A display device (500) comprising a plurality of picture cells (502) and means (503, 505, 507, 509) for:
receiving an image signal comprising image data relating to said plurality of picture cells, said image data being temporally arranged in frames,
controlling, in dependence on at least said image data, a respective electric field across each picture cell in said plurality of picture cells, comprising means for:
controlling, according to a first polarity inversion scheme, polarity of the electric field such that polarity inversion occurs at regular intervals, said regular intervals being a fixed integer number of frame periods, and
controlling, according to a second polarity inversion scheme concurrent with said first polarity inversion scheme, polarity of the electric field such that polarity inversion occurs at pseudo-random intervals, said pseudo-random intervals being a respective integer number of frame periods.

13. The display device according to claim 12, comprising means for analyzing the image data, configured to output results in the form of calculated correlation values between a number of frames, and where the number of frame periods between two consecutive polarity inversions according to the second scheme is depending on results output from the means for analyzing the image data.
